(19) United States
(12) Patent Application Publication
(10) Pub. No.: US 2011/0303878 A1
(43) Pub. Date: Dec. 15, 2011

(54) Conducting Polymer Synthesized with Partially Substituted Polymers as a Dopant

(76) Inventors: Kwang Suck SUH, Seongnam-si (KR); Jong Eun Kim, Seoul (KR); Tae Young Kim, Seoul (KR)

(21) Appl. No.: 13/211,056

(22) Filed: Aug. 16, 2011

Related U.S. Application Data
(62) Division of application No. 11/997,312, filed on Jul. 11, 2008, now abandoned.

(30) Foreign Application Priority Data
Jul. 29, 2005 (KR) 10-2005-0069226

(51) Int. Cl. H01B 1/12; C08F 212/08; C08F 236/10

(52) U.S. Cl. 252/500; 525/332.9; 525/333.5

(57) ABSTRACT

Disclosed herein is a method of synthesizing a conducting polymer using a polymer, having a substituent in a part, as a dopant, in which a variety of polymers is substituted with a predetermined functional group to serve as a dopant such that the substituted functional group functions as the dopant of the conducting polymer, or a monomer having a substituent able to act as a dopant is copolymerized to prepare a polymer dopant having a substituent in a part thereof. The partially substituted polymer dopant may serve as a dopant upon synthesis of the conducting polymer or upon additional doping of the synthesized polymer. Compared to a conventional monomer dopant, the polymer dopant does not emit low-molecular-weight material, and has higher solubility. Further, compared to a polymer dopant having a substituent such as a sulfonic acid group throughout, the synthesized conducting polymer can have superior mechanical properties and maximum conductivity.

### RELATED APPLICATION

This application is a divisional application of U.S. patent application Ser. No. 11/997,312 for “Conducting Polymer Synthesized with Partially Substituted Polymers as a Dopant” filed on Jul. 11, 2008.

### BACKGROUND OF THE INVENTION

The present invention relates to a method of synthesizing a conducting polymer using a polymer dopant having a substituent in a part thereof, and more particularly, to a method of synthesizing a conducting polymer, which has a partially substituted part in a desired position and amount in order to function as a dopant of the conducting polymer and the remaining unsubstituted part responsible for maintaining mechanical properties or determining solubility in a solvent.

Generally, a conducting polymer, which originates from an electrical insulator, is imparted with electrical conductivity through a doping process. Further, the conducting polymer has very low solubility due to strong interaction of delocalized double bonds thereof. To use the conducting polymer, a doping process is required to manifest electrical conductivity. In addition, the conducting polymer should have solubility suitable for commercial application on antistatic products or electromagnetic interference (EMI) shielding materials. Thus, with the goal of improving conductivity and solubility, the use of a dopant is essential. As such, in order to function as a dopant, a predetermined compound should form a polaron on the main chain of a conducting polymer and should have dissociation properties because it is positively or negatively charged.

To this end, the dopant for use in the conducting polymer is mainly exemplified by compounds having a functional group, such as a phosphoric acid group, a carboxylic acid group or a sulfonic acid group. Of these compounds, a compound having a sulfonic acid group is most preferable in the interest of high conductivity and superior doping properties. In particular, among compounds having a sulfonic acid group, examples of a monomer compound include dodecylbenzene sulfonic acid, camphor sulfonic acid, para-toluene sulfonic acid, naphthalene sulfonic acid, ferric toluene sulfonic acid, trifluoromethyl sulfonic acid, and bromobenzene sulfonic acid, and examples of a polymer dopant include polystyrene sulfonic acid. However, these dopants have some problems. That is, although the monomer sulfonic acid, such as dodecylbenzene sulfonic acid, has relatively good doping properties, it may be removed from the main chain of the conducting polymer during use, which can be attributed to its low molecular weight. In addition, under conditions of a high temperature and a long period of time, dedoping of the dopant may occur. Further, a conventional dopant, such as 100% sulfonated polystyrene sulfonic acid, is commercially available in the form in which a conducting polymer is connected with the main chain of a sulfonated styrene polymer having a high molecular weight, and is thus doped therewith (Baytron P, Bayrton P H, H. C. Starck), but has two disadvantages. First, the 100% sulfonated styrene polymer has poor properties because it would become too brittle in mechanical properties due to the presence of ions on the main polymer chain. Second, 100% sulfonated polymer is highly polar and is therefore soluble only in water.

Ultimately, there is a need for the development of techniques for synthesizing a conducting polymer having excellent mechanical properties while suppressing the dedoping properties of a monomeric dopant and having reasonably good solubility in solvents other than water.

### SUMMARY OF THE INVENTION

The present invention has been made keeping in mind the above problems occurring in the prior art, and an object of the present invention is to provide a method of synthesizing a conducting polymer, which adopts a partially substituted oligomer or polymer as a dopant of the conducting polymer, thus exhibiting less dedoping properties than when using a monomer dopant, better mechanical properties and better solubility in solvents other than water than when using a polymer dopant having only sulfonic acid group throughout.

In order to achieve the above object, the present invention provides a conducting polymer comprising a dopant, in which the dopant is a polymer, an oligomer, or a mixture of polymer and oligomer, having a substituent in a part thereof, and is used to synthesize the conducting polymer, the conducting polymer synthesized due to the dopant being dissolved in water or an organic solvent and exhibiting superior mechanical properties.

In addition, the present invention provides a method of synthesizing a conducting polymer, comprising substituting a part of a polymer or oligomer with a substituent, thus forming a dopant; and mixing a monomer of the conducting polymer with the polymer having a sulfonic acid group in the part thereof, thus synthesizing a doped conducting polymer, which is then washed and dried to remove unreacted material, or synthesizing a conducting polymer, which is then mixed with a partially sulfonated polymer which has been previously prepared and purified, and then performing doping.

As such, the dopant is prepared by introducing a sulfonic acid group to a polymer which may undergo sulfonation or by copolymerizing a monomer having a sulfonic acid group to form a partially sulfonated oligomer or polymer.

According to the present invention, when synthesizing the conducting polymer, since a polymeric dopant having a substituent in a part thereof is used, it may suppress the dedoping properties caused upon use of a monomeric dopant, and thus functions stably. Further, compared to the limited solubility and low mechanical properties of a polymer having a substituent such as a sulfonic acid group throughout, the synthesized conducting polymer of the present invention may have higher mechanical properties and better solubility due to the presence of the unsubstituted part therein.

### DETAILED DESCRIPTION EMBODIMENTS OF THE INVENTION

The U.S. patent application Ser. No. 11/997,312 is incorporated by reference into this disclosure as if fully set forth herein.

Based on the present invention, a dopant is an oligomer and/or a polymer which are partially substituted with a typical functional group, such as a sulfonic acid group, a phosphoric acid group, and a carboxylic acid group. In this way, the present invention is characterized in that the conducting polymer is synthesized using an oligomer and/or polymer dopant having a substituent in a part thereof. The conducting polymer thus synthesized is advantageous because the dedoping properties are suppressed and mechanical properties are improved more than when using a conventional monomeric dopant. Below, the application of a sulfonic acid group is described as an example.

In the present invention, a procedure of preparing a sulfonic acid oligomer or polymer, which is partially sulfonated to be useful as a dopant, is regarded as very important. This is because part of a polymer chain is sulfonated to function as a dopant, while the other part thereof, which is not sulfonated, is responsible for determining the solubility and mechanical properties. The process of preparing the partially sulfonated polymer is classified into two techniques.

As a first technique, a process of introducing a sulfonic acid group to a previously prepared polymer may be employed. To this end, any polymer may be used so long as a sulfonic acid group is introduced thereto. In particular, when a styrenic polymers or an epoxy-based polymer having a double bond is used, sulfonation may efficiently take place, leading to a high sulfonation yield. For example, in the case of a polystyrene (PS) polymer, sulfonation may occur at a para-position of styrene. As such, examples of the styrene-based polymer include tert-butyl styrene, styrene substituted with one or two chlorine atoms, styrene polymers substituted with a methyl group at an ortho- or para-position thereof, and various styrene copolymers, for instance, all the copolymers containing styrene, such as styrene-ethylene-butylene-styrene (SEBS), styrene-butadiene-styrene (SBS), styrene-isoprene-styrene (SIS), acrylonitrile-butadiene-styrene (ABS), styrene-acrylonitrile (SAN), styrene-methacrylic acid (SMA), etc. In addition, polymers in which another compound is grafted to the above polymers are useful. Further, it is possible to use polymers whose repeating unit is C2-C4 having at least one double bond, and also to use copolymers containing such functional groups. Furthermore, polymers having an epoxy group and copolymers including an epoxy group may be used. Moreover, sulfonation of the compound having an ether group, a ketone group, an acryl group, or a maleyl group may be realized.

Since the conducting polymer is doped, in the case where partial sulfonation proceeds, the use of block polymer form is preferable. As such, partial sulfonation enables the intensive distribution of a sulfonic acid group on one substitution site compared to sulfonation throughout, thus further increasing doping efficiency.

As a second technique, a process of copolymerizing a compound having a sulfonic acid group with another monomer may be applied. That is, sulfonic styrene, resulting from substitution of styrene with a sulfonic acid group at the ortho-, meta- or para-position thereof, may be copolymerized with another monomer. When a compound having a sulfonic acid group introduced to the above-mentioned double bond moiety or a monomer in which a sulfonic acid group is introduced to an epoxy group is used for general copolymerization, an oligomer or polymer having a sulfonic acid group introduced in a part thereof may be prepared.

The degree of partial sulfonation falls in the range of 10-80%, based on the total polymer including the block copolymer. If the degree of sulfonation is less than 10%, effective doping does not take place due to the small quantity of the sulfonic acid group. On the other hand, when the sulfonation exceeds 80%, mechanical properties may become worse.

For the sulfonation of the synthesized polymer in the first technique, sulfonation may take place on the position of styrene and on the double bond moiety thereof using various processes. For example, a sulfonation method, which was initially proposed, was performed in the presence of SO₃ or HSO₃Cl at −20° C. using chloroform. Of some sulfonation methods, according to the sulfonation technique developed by Turbak et al., a uniform sulfonation procedure was suggested by mixing triethyl phosphate and SO₃ with a dichloroethane solution at room temperature upon the uniform introduction of a sulfonic acid group to polystyrene. This sulfonation procedure may effectively prevent the drastic reduction of solubility due to the production of a compound having a macromolecular weight, as a result of crosslinking due to SO₃ in the former sulfonation using only SO₃ or HSO₃Cl, leading to a good solution state of sulfonated polymer.

Makowski et al. disclosed the use of acetic sulfonate as a sulfonation material at 50° C. for 1 hour, in which acetyl sulfonate is derived from acetyl sulfonic acid prepared through a reaction of sulfuric acid and acetic anhydride in dichloroethane immediately before the sulfonation. This method can yield a sulfonic acid polymer having a same molecular weight as before without crosslinking reaction.

In addition, sulfonic acid introduction methods include the use of a sulfonation material prepared by dissolving chlorosulfonic acid in chloroform, the use of a mixture comprising sulfuric acid and phosphonic acid, or the use of acetyl sulfate.

In this way, various sulfonic acid introduction materials may be utilized. The degree of sulfonation is in proportion to the amount of sulfonation material to be added and the amount of oligomer or polymer to be used. That is, the molecular weight of oligomer or polymer to be substituted with a sulfonic acid group and the sulfonation % per unit are calculated such that a sulfonic acid group is introduced in a desired amount.

After the completion of the introduction of a sulfonic acid group, in the case where the resulting product is liquid, an alkaline material such as NaOH is added to induce neutralization. In this case, since the sulfonic acid group reacts with Na and thus is neutralized, it may maintain stable during subsequent washing and drying procedures.

There are some notes to be made about the sulfonation procedure. After the completion of sulfonation, in the case where the compound such as sulfonic acid added for sulfonation remains in the synthesized material, it may react with water when performing the drying process following the washing process or when allowing it to stand in air, undesirably corroding or burning the polymer. Therefore, the washing process is regarded as very important for complete removal of the unreacted material. At this time, from the partially sulfonated polymer thus synthesized, ions are removed using a cation-anion exchange resin, thereby removing a large amount of unreacted material. As the cation or anion exchange resin, any resin may be used so long as it exchanges the sulfonic acid group used and the other ions. Further, when the washing and drying processes are performed several times, impurities may be removed. To this end, water or C1-C4 alcohol is used to repeat the washing and drying processes. In particular, a vacuum drying process at 20-80° C. is adopted to effectively remove the impurities.

The polymer, which may undergo sulfonation, is not limited to the above-mentioned polymers, and any polymer may be used so long as it is subjected to sulfonation. Further, the degree of sulfonation can be controlled depending on the wt % of copolymer which may be subjected to sulfonation, other than polymers which can be wholly sulfonated. Furthermore, the polymer, serving as the dopant, preferably has a molecular weight of 1,000-1,000,000. In addition, it is preferred that a polymer having a controlled molecular weight be used to increase solubility in water or in other solvents after the sulfonation.

In the second technique, in order to obtain the partially sulfonated oligomer or polymer, a monomer having a sulfonic acid group may be copolymerized with another monomer.

For example, in the case of preparing a styrene-butadiene copolymer, a polymerization process is performed such that the synthesized copolymer has a styrene functional group block having a predetermined length, or such that styrene and butadiene are randomly arranged.

Particularly, polymerization for random distribution of two monomers in the polymer chain proceeds in the presence of a polar organic compound or sodium, potassium, analogous compounds thereof, or an organic salt complex, along with sulfonated styrene and butadiene. In addition, an organic lithium compound and a Lewis base are simultaneously used, and thus a randomly arranged sulfonated styrene-butadiene copolymer may be prepared. In addition, it is possible to perform polymerization using an emulsion polymerization process or a Ziegler-Natta catalyst, and also, it is possible to realize copolymerization capable of improving the properties of a copolymer, such as processibility, constriction resistance, and prevention of gelling, through a coupling reaction using a coupling agent along with a lithium initiator.

Further, upon the preparation of a sulfonated styrene-butadiene copolymer, a process of using a nucleic acid or isoprene compound to function as a molecular weight controller may be applied.

Although the above-mentioned methods correspond to a polymerization process for introducing a sulfonic acid group toward styrene, they may be applied to the synthesis of a copolymer by introducing a compound having a double bond, such as butadiene, with a sulfonic acid group and then copolymerizing it with a styrene compound. That is, the use of a compound such as sulfonated butadiene or sulfonated isoprene results in a partially sulfonated copolymer, which may be realized using the above copolymer preparation process.

In the second technique, in addition to the copolymer synthesis method for randomly arranging two or more materials, a polymerization process causing a functional group to be regularly present may be used. That is, material is added at a predetermined interval using tetrahydrofuran as a polymerization controller in the presence of a hydrocarbon solvent, thus obtaining a block copolymer.

Further, any copolymer synthesis method may be used in the present invention, and therefore partially sulfonated copolymers may be prepared in a desired form using monomers having a sulfonic acid group, a phosphoric acid group and a carboxylic acid group through various polymerization processes. In order to enhance a doping effect and to realize desired properties partially, it is preferred that a block copolymer be synthesized. However, since the doping level does not reach 100% per unit, it is possible to use the partially sulfonated polymer, regardless of whether it is a block type or random type, depending on the doping efficiency and size of the monomer of the conducting polymer.

In the present invention, a monomer for use in the synthesis of the conducting polymer can be, for example, aniline, pyrrole, thiophene, furan, etc. Also, to increase solubility in water and a solvent, derivative monomers substituted with various functional groups may be used. For example, there are cyclic materials substituted with a sulfonic acid group, an amino group, a hydroxyl group, a C1-C4 alkylenehydroxyl group, a C1-C4 alkoxy group, a C1-C12 alkyl group, and a C1-C4 alkylenedioxy group. Furthermore, to increase solubility in an organic solvent, useful are monomer compounds substituted with a C1-C12 alkyl group, an ether group, an ester group, a urethane group and a sulfonic acid group at a single carbon position of the above cyclic material. In particular, thiophene substituted with an ethylenedioxy group at 3,4-positions thereof has a low band gap and thus exhibits excellent optical properties. Also, since thiophene is substituted at 3,4-positions thereof, a desired reaction efficiently takes place at 2,5-positions, and hence the yield is high and thermal stability is good. Consequently, the use of thiophene is preferable. In addition, for high solubility in water and a solvent, 3,4-alkylenedioxy thiophene having sulfonic acid, ether, urethane or ester substituted on any one carbon of ethylene is preferably used.

Moreover, the synthesis of the sulfonic acid polymer and conducting polymer requires the use of an oxidant, which is exemplified by peroxy sulfonic acid, sodium persulfate, potassium persulfate, ammonium persulfate, iron (III) and salts of iron-inorganic acid such as hydrochloric acid, sulfonyl acid, nitric acid or phosphoric acid, iron (III) and salts of iron-organic acid, such as para-toluene sulfonic acid, benzene sulfonic acid, methane sulfonic acid or trifluoromethane sulfonic acid, hydrogen peroxide, potassium permanganate, potassium dichromate, perboric acid, and salts of copper-organic acid or inorganic acid. In particular, when the oxidant functions not only as the oxidant but also as a dopant, the doping properties of the partially sulfonated polymer dopant, which is synthesized for use in the present invention, gets worse. Preferably, among the oxidants, ammonium persulfate ((NH₄)₂S₂O₈), sodium persulfate (Na₂S₂O₈), or potassium persulfate (K₂S₂O₈) is preferable because it may be washed with water and alcohol after synthesis. When a small amount of ferric toluene sulfonic acid oxidant is used, the reaction rate favorably increases. However, since such an oxidant disturbs the doping of the partially sulfonated polymer, it should be used in an amount of less than 30 parts by weight based on the total amount of oxidant.

In the present invention, the polymer having a sulfonic acid group in a part thereof, the monomer of the conducting polymer, and the oxidant are dissolved in a solvent for synthesis. As such, examples of the usable solvent include water, C1-C4 alcohols, acetone, toluene, xylene, chloroform, methylene chloride, ethyleneglycol monomethylether, ethyleneglycol monoethylether, ketones such as N-methyl-2-pyrrolidinone, amides, and glycols. As the solvent, any solvent may be used so long as it may dissolve the polymer having a sulfonic acid group in a part thereof and the oxidant. To this end, a glycol solvent miscible with water may be mixed with water, or a solvent mixture comprising toluene and alcohol may be used. The synthesis of the conducting polymer is not limited to these types of solvent. Any solvent or solvent mixture may be used so long as it dissolves the partially sulfonated polymer and the oxidant.

In addition to the partially substituted sulfonic acid polymer dopant, when a monomeric dopant, such as camphor sulfonic acid, dodecyl sulfonic acid, or dodecylbenzene sulfonic acid is added in a small amount, an acid value is increased upon the synthesis, leading to a fast reaction rate and a high yield. However, since the main dopant is the partially sulfonated polymer, the monomer dopant is preferably used in an amount of 0.1-1 parts by weight, based on the weight of the partially sulfonated polymer dopant.

A better understanding of the present invention may be obtained in light of the following comparative examples and examples which are set forth to illustrate, but are not to be construed to limit the present invention.

### COMPARATIVE EXAMPLE 1

In Comparative Example 1, polyethylenedioxythiophene was synthesized using 100% sulfonated polystyrene sulfonic acid (PSSA) as a dopant and ammonium persulfate (APS) as an initiator. To this end, into a 250 ml round-bottom flask, 25 parts by weight of polystyrene sulfonic acid (PSSA), 5 parts by weight of ammonium persulfate (APS), 15 parts by weight of ethylenedioxythiophene (EDOT) and 55 parts by weight of water were sequentially added and then magnetically stirred at 25° C. for 24 hours, thereby preparing polyethylenedioxythiophene doped with polystyrene sulfonic acid.

The polyethylenedioxythiophene thus synthesized was filtered using a 1 mm sized filter to have a particle size of less than 1 mm, and then passed through an ion exchange resin (Lewatit MonoPlus S100), thereby removing the remaining initiator ions. As such, in the case where the polyethylenedioxythiophene obtained in a solid state was dissolved (dispersed) in water and methanol in a weight ratio of 10, it was confirmed to be highly dissolved (dispersed). Further, in the case where polyethylenedioxythiophene was applied on a polyethylene terephthalate (PET) film, a surface resistance of 10E3-10E4 ohms/square was measured.

The sample for evaluation of other properties was prepared by mixing 5 parts by weight of polyethylenedioxythiophene, synthesized as above, 25 parts by weight of a polyurethane binder, 30 parts by weight of isopropylalcohol and 40 parts by weight of water to prepare a solution, which was then applied to a thickness of about 1 mm on the PET film, followed by drying the film in an oven at 80° C. for 1 min. As such, the surface resistance of the film was measured to be 10E5 ohms/square. In addition, after the coating surface of the film was rubbed both ways five times using a cotton swab, the surface resistance of the rubbed portion was measured to be 10E12 ohms/square.

### COMPARATIVE EXAMPLE 2

Comparative Example 2 was performed in the same manner as in Comparative Example 1, with the exception that a mixture comprising ferric toluenesulfonate (FTS) and ammonium persulfate (APS), mixed at a weight ratio of 50:50, was used as the initiator. The polyethylenedioxythiophene thus synthesized was dissolved (dispersed) in water and methanol, and the results thereof were observed. As the result, solubility was high in water but was low in methanol.

### EXAMPLE 1

In Example 1, butadiene portion of a styrene-butadiene-styrene (SBS) copolymer having 30% styrene was partially sulfonated to prepare a dopant. Subsequently, polyethylenedioxythiophene was synthesized using the above dopant and an ammonium persulfate initiator. As such, in order to produce the partially sulfonated styrene-butadiene-styrene, chlorosulfonic acid was added dropwise to 1,4-dioxane in a nitrogen atmosphere, thus preparing a sulfonation material containing chlorosulfonic acid and 1,4-dioxane at 10:1. The styrene-butadiene-styrene having 30% styrene was dissolved in 1,4-dioxane to the weight ratio of 10%, after which the sulfonated material was added dropwise thereto, followed by performing a magnetic stirring process at room temperature for 3 hours, whereby the butadiene of styrene-butadiene-styrene was 60% sulfonated. After the magnetic stirring process, the resulting solution was added with predetermined amounts of aqueous sodium hydroxide solution and isopropyl alcohol, thus completing the reaction. The resulting reaction product was solidified, washed, and dried, yielding partially sulfonated styrene-butadiene-styrene.

The procedure of preparing polyethylenedioxythiophene using the partially sulfonated styrene-butadiene-styrene as a dopant and the ammonium persulfate as an initiator was the same as in Example 1. In the case where the polyethylene-dioxythiophene thus obtained was dissolved (dispersed) in water and methanol to the weight ratio of 10%, it was confirmed to be highly dissolved (dispersed). Further, in the case where polyethylenedioxythiophene was applied on a PET film, surface resistance of 10E5 ohms/square was measured.

In addition, in the case where polyethylenedioxythiophene was mixed with the above dopant and the polyurethane binder as in Comparative Example 1 and then applied on the film, the surface resistance of the film was measured to be 10E6 ohms/square. Moreover, after coating the surface of the film was rubbed both ways five times using a cotton swab, the surface resistance of the rubbed portion was measured to be 10E9 ohms/square.

### EXAMPLE 2

Example 2 was performed in the same manner as in Example 1, with the exception that a mixture comprising ferric toluene sulfonate (FTS) and ammonium persulfate (APS) mixed at a weight ratio of 50:50 was used as the initiator. As a result of dissolution (dispersion) of polyethylenedioxythiophene thus synthesized in water and methanol, it was observed to have high solubility in water and about 40% solubility in methanol.

### EXAMPLE 3

Example 3 was performed in the same manner as in Example 2, with the exception that the butadiene portion of styrene-butadiene-styrene was 100% sulfonated. As a result of dissolution (dispersion) of polyethylenedioxythiophene thus synthesized in water and methanol, it was observed to have high solubility in water and about 80% solubility in methanol.

### EXAMPLE 4

Example 4 was performed in the same manner as in Example 1, with the exception that the styrene portion of styrene-ethylene-butylene-styrene was 100% sulfonated to serve as a dopant.

Using the styrene-ethylene-butylene-styrene thus sulfonated as the dopant and ammonium persulfate as the initiator, polyethylenedioxythiophene was synthesized as in Comparative Example 1. The polymer thus obtained was highly dissolved (dispersed) in both water and methanol. Further, in the case where the obtained polymer was applied on a polyethylene terephthalate (PET) film, it was confirmed to have surface resistance of 10E4-10E5 ohms/square.

In addition, in the case where the obtained polymer was mixed with the above dopant and the polyurethane binder as in Comparative Example 1 and then applied on the film, the surface resistance of the film was measured to be 10E6 ohms/square. Moreover, after the coating surface of the film was rubbed both ways five times using a cotton swab, the surface resistance of the rubbed portion was measured to be 10E7 ohms/square.

As previously described herein, the conducting polymer, which is synthesized using the partially substituted polymer dopant, can be applied to various fields in place of conventional conducting polymers. For example, the conducting polymer of the present invention may be formed into an antistatic coating layer in various films or sheets, and may also be applied to conductive antistatic products or electromagnetic interference shielding materials.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A dopant for use in synthesis of a conducting polymer, which is a polymer, an oligomer, or a polymer and oligomer, having a substituent in a part thereof, and which is used to synthesize the conducting polymer, the conducting polymer synthesized due to the dopant being dissolved in water or an organic solvent and having superior mechanical properties.

2. The partially substituted dopant according to claim 1, wherein the polymer or oligomer having the substituent in a part thereof is formed by introducing a substituent to a prepared polymer or oligomer.

3. The partially substituted dopant according to claim 2, wherein the substituent is a sulfonic acid group, a phosphoric acid group, or a carboxylic acid group.

4. The partially substituted dopant according to claim 3, wherein a polymer having the sulfonic acid group comprises styrene-, epoxy-, carboxyl-, ether-, ketone-, aldehyde-based polymers, and all polymers having double bonds.

5. The partially substituted dopant according to claim 1, wherein the substituent is a sulfonic acid group, a phosphoric acid group, or a carboxylic acid group.

6. The partially substituted dopant according to claim 5, wherein a polymer having the sulfonic acid group comprises styrene-, epoxy-, carboxyl-, ether-, ketone-, aldehyde-based polymers, and all polymers having double bonds.

7. The partially substituted dopant according to claim 1, wherein the polymer or oligomer having the substituent in the part thereof is provided in a form of a copolymerized polymer or oligomer through polymerization of a monomer having a substituent.

8. The partially substituted dopant according to claim 7, wherein the substituent is a sulfonic acid group, a phosphoric acid group, or a carboxylic acid group.

9. The dopant according to claim 8, wherein the copolymerized polymer having the substituent in the part thereof is prepared through copolymerization of any monomer having a sulfonic acid group, a phosphoric acid group, or a carboxylic acid group.

10. A method of synthesizing a conducting polymer, comprising:
substituting a part of a polymer or oligomer with a substituent, thus forming a dopant;
mixing a monomer of the conducting polymer with the polymer having a sulfonic acid group in the part thereof, thus synthesizing a doped conducting polymer, which is then washed and dried to remove unreacted material, or synthesizing a conducting polymer, which is then mixed with a partially sulfonated polymer, which has been previously prepared and purified, and then performing doping.

11. The method according to claim 10, wherein the forming of the dopant is performed by introducing a sulfonic acid group to a polymer able to be sulfonated or by copolymerizing an oligomer or polymer having a sulfonic acid group in a part thereof using a monomer having a sulfonic acid group.
